(19) United States
(12) Patent Application Publication
(10) Pub. No.: US 2013/0006760 A1
(43) Pub. Date: Jan. 3, 2013

(54) SYSTEMS AND METHODS FOR PRESENTING COMPARATIVE ADVERTISING

(76) Inventor: Walter Brenner, Vancouver (CA)

(21) Appl. No.: 13/175,033

(22) Filed: Jul. 1, 2011

(51) Int. Cl. G06Q 30/00

(52) U.S. Cl. 705/14.49

(57) ABSTRACT

Methods for displaying advertisements on a computer are provided. One method includes: detecting keyword information from a source module with a data processor wherein the keyword information is visible to a user on a display component of the computer; comparing the keyword information to a keyword database wherein the keyword database associates the keyword information with one or more keywords; comparing the one or more keywords to an advertisement database wherein the advertisement database associates the one or more keywords with one or more advertisements; and displaying the one or more advertisement on the display component through a sidebar module, wherein the sidebar module is viewable by the user independently of the visibility of the source module. The advertisements may be ranked according to perceived user benefit and/or social-media popularity. Associated computer program products and advertisement display systems are also provided.

### TECHNICAL FIELD

This disclosure relates to the field of comparative advertising.

### BACKGROUND

Any discussion of the prior art throughout the specification should in no way be considered as an admission that such prior art is widely known or forms part of general common knowledge in the field.

Individuals often want to search for information. Searches are often done on an electronic medium using an electronic search platform. Information searches are often done on a electronic network, such as the Internet, using a search platform via a web browser. Many providers of search platforms provide search services to users free of charge but to offset the cost also display advertisements to the users. It is useful for the user, and more effective for the advertisers, to have advertisements presented to the user that are relevant to the subject of the user's search. These searches are commonly known as sponsored searches.

Sponsored searches often provide advertisements to users based on the keyword click bid amount that an advertiser has paid to the search platform provider. Advertisers that have paid more to the search platform provider may have their advertisements preferentially presented to users. As a result, advertisements that users would prefer to be shown, or would provide the most benefit to the users, are not necessarily presented.

In addition, because advertisements are provided in conjunction with the use of search platforms, they are often displayed with the search results generated by the search platform. Using the example of an Internet search platform, after a user enters a search query, advertisements are often provided on the same website page as the search results. Therefore, when a user investigates the results of a search by viewing other website pages, the advertisements are no longer visible to the user. This is disadvantageous for the advertisers.

Similarly, if a user closes the website page displaying their search results, by terminating the web browser program for example, the advertisements are no longer displayed to the user. This results in less viewing time of the advertisements, to the detriment of the advertisers' interest.

The foregoing examples of the related art and limitations related thereto are intended to be illustrative and not exclusive. Other limitations of the related art will become apparent to those of skill in the art upon a reading of the specification and a study of the drawings.

There remains a need for effective systems and methods for presenting comparative advertising which ameliorate at least some of the disadvantages of existing systems.

### SUMMARY

This summary is provided to introduce a selection of representative concepts and aspects of the invention in a simplified form that are further described below in the description. This summary is not intended to identify key features or essential features of the claimed subject matter, nor is it intended to be used in any way that would limit the scope of the claimed subject matter.

One aspect of the invention provides a method for displaying advertisements on a computer. The method comprises:

detecting keyword information from a source module with a data processor wherein the keyword information is visible to a user on a display component of the computer;

comparing the keyword information to a keyword database wherein the keyword database associates the keyword information with one or more keywords;

comparing the one or more keywords to an advertisement database wherein the advertisement database associates the one or more keywords with one or more advertisements; and

displaying the one or more advertisement on the display component through a sidebar module, wherein the sidebar module is viewable by the user independently of the visibility of the source module.

Another aspect of the invention provides a computer program product comprising a computer readable medium having control logic stored therein for causing a computer to display advertisements on the computer, the control logic comprising:

first computer readable program code means for causing the computer to detect keyword information from a source module with a data processor wherein the keyword information is visible to a user on a display component of the computer;

second computer readable program code means for causing the computer to compare the keyword information to a keyword database wherein the keyword database associates the keyword information with one or more keywords;

third computer readable program code means for causing the computer to compare the one or more keywords to an advertisement database wherein the advertisement database associates the one or more keywords with one or more advertisements; and

fourth computer readable program code means for causing the computer to display the one or more advertisement on the display component through a sidebar module, wherein the sidebar module is viewable by the user independently of the visibility of the source module.

Another aspect of the invention provides an advertisement display system comprising:
a source module running on a computer;
a processor configured to detect keyword information from the source module;
a keyword database;
a processor configured to derive one or more keywords based on a comparison between the keyword information and the keywords stored in the keyword database;
an advertisement database which stores a plurality of advertisements, each advertisement being associated with one or more advertisement keywords;
a processor configured to select one or more advertisements based on a comparison between the one or more keywords and the one or more advertisement keywords;
a data transmission component configured to transmit the one or more selected advertisements to the computer; and
a sidebar comprising a display component configured to display the one or more selected advertisements, wherein the sidebar is independently viewable from the source module.

Another aspect of the invention provides a method for displaying advertisements on a computer comprising:

detecting keyword information from a source module with a data processor wherein the keyword information is visible to a user on a display component of the computer;

comparing the keyword information to a keyword database wherein the keyword database associates the keyword information with one or more keywords;

comparing the one or more keywords to an advertisement database wherein the advertisement database associates the one or more keywords with one or more advertisements;

ranking the one or more advertisements according to perceived user benefit;

displaying the one or more advertisements on the display component according to their ranking.

Another aspect of the invention provides a computer program product comprising a computer readable medium having control logic stored therein for causing a computer to display advertisements on the computer, the control logic comprising:

first computer readable program code means for causing the computer to detect keyword information from a source module with a data processor wherein the keyword information is visible to a user on a display component of the computer;

second computer readable program code means for causing the computer to compare the keyword information to a keyword database wherein the keyword database associates the keyword information with one or more keywords;

third computer readable program code means for causing the computer to compare the one or more keywords to an advertisement database wherein the advertisement database associates the one or more keywords with one or more advertisements;

fourth computer readable program code means for causing the computer to rank the one or more advertisements according to perceived user benefit; and

fifth computer readable program code means for causing the computer to display the one or more advertisements on the display component according to their perceived user benefit ranking.

Another aspect of the invention provides an advertisement display system comprising:
a source module running on a computer;
a processor configured to detect keyword information from the source module;
a keyword database;
a processor configured to derive one or more keywords based on a comparison between the keyword information and the keywords stored in the keyword database;
an advertisement database which stores a plurality of advertisements, each advertisement being associated with one or more advertisement keywords;
a processor configured to select one or more advertisements based on a comparison between the one or more keywords and the one or more advertisement keywords and to rank the one or more selected advertisements according to perceived user benefit;
a data transmission component configured to transmit the one or more ranked advertisements to the computer; and
a display component configured to display the one or more ranked advertisements according to their perceived user benefit rank.

Another aspect of the invention provides a method for displaying advertisements on a computer comprising:

detecting keyword information from a source module with a data processor wherein the keyword information is visible to a user on a display component of the computer;

comparing the keyword information to a keyword database wherein the keyword database associates the keyword information with one or more keywords;

comparing the one or more keywords to an advertisement database wherein the advertisement database associates the one or more keywords with one or more advertisements;

ranking the one or more advertisements according to social-media popularity; and

displaying the one or more advertisements on the display component according to their social-media popularity ranking.

Another aspect of the invention provides a computer program product comprising a computer readable medium having control logic stored therein for causing a computer to display advertisements on the computer, the control logic comprising:

first computer readable program code means for causing the computer to detect keyword information from a source module with a data processor wherein the keyword information is visible to a user on a display component of the computer;

second computer readable program code means for causing the computer to compare the keyword information to a keyword database wherein the keyword database associates the keyword information with one or more keywords;

third computer readable program code means for causing the computer to compare the one or more keywords to an advertisement database wherein the advertisement database associates the one or more keywords with one or more advertisements;

fourth computer readable program code means for causing the computer to rank the one or more advertisements according to social-media popularity; and

fifth computer readable program code means for causing the computer to display the one or more advertisements on the display component according to their social-media popularity ranking.

Another aspect of the invention provides an advertisement display system comprising:
a source module running on a computer;
a processor configured to detect keyword information from the source module;
a keyword database;
a processor configured to derive one or more keywords based on a comparison between the keyword information and the keywords stored in the keyword database;
an advertisement database which stores a plurality of advertisements, each advertisement being associated with one or more advertisement keywords;
a processor configured to select one or more advertisements based on a comparison between the one or more keywords and the one or more advertisement keywords and to rank the one or more advertisements according to social-media popularity;
a data transmission component configured to transmit the one or more ranked advertisements to the computer; and
a display component configured to display the one or more ranked advertisements according to their social-media popularity rank.

Another aspect of the invention provides a method for displaying advertisements comprising the steps of:

detecting keyword information input by a user into a search engine via a terminal with a terminal processor;

deriving keywords from the keyword information with the terminal processor;

transmitting the keywords to a server connected to the terminal via a network;

selecting a plurality of advertisements stored in a database on the server wherein the advertisements correspond to the keywords;

sorting the advertisements according to a social-media popularity ranking and/or a perceived user benefit ranking, wherein the social-media popularity ranking is determined according to the number of social-media associations created by users to an advertisement, an advertiser, a promotion, and/or a product or a service, and the perceived user benefit ranking is determined according to a monetary value of a promotion offered by an advertiser, a time period of the promotion, and/or a geographical proximity of the promotion to the user;

communicating the advertisements from the server to the terminal; and

displaying the ranked advertisements to the user of the terminal through a sidebar, wherein the sidebar is viewable to the user independent of visibility of the search engine

Another aspect of the invention provides a computer program product comprising a computer readable medium having control logic stored therein for causing a computer to display advertisements on the computer, the control logic comprising:

first computer readable program code means for causing the computer to detect keyword information from a source module with a data processor wherein the keyword information is visible to a user on a display component of the computer;

second computer readable program code means for causing the computer to derive keywords from the keyword information with the terminal processor;

third computer readable program code means for causing the computer to transmit the keywords to a server connected to the terminal via a network;

fourth computer readable program code means for causing the computer to select a plurality of advertisements stored in a database on the server wherein the advertisements correspond to the keywords;

fifth computer readable program code means for causing the computer to rank the advertisements according to a social-media popularity ranking and/or a perceived user benefit ranking, wherein the social-media popularity ranking is determined according to the number of social-media associations created by users to an advertisement, an advertiser, a promotion, and/or a product or a service, and the perceived user benefit ranking is determined according to a monetary value of a promotion offered by an advertiser, a time period of the promotion, and/or a geographical proximity of the promotion to the user;

sixth computer readable program code means for causing the computer to communicate the advertisements from the server to the terminal; and

seventh computer readable program code means for causing the computer to display the ranked advertisements to the user of the terminal through a sidebar, wherein the sidebar is viewable to the user independent of visibility of the search engine.

Another aspect of the invention provides an advertisement display system comprising:
a source module running on a computer;
a processor configured to detect keyword information from the source module;
a keyword database;
a processor configured to derive one or more keywords based on a comparison between the keyword information and the keywords stored in the keyword database;
an advertisement database which stores a plurality of advertisements, each advertisement being associated with one or more advertisement keywords;
a processor configured to select one or more advertisements based on a comparison between the one or more keywords and the one or more advertisement keywords and to rank the one or more selected advertisements according to a social-media popularity ranking and/or a perceived user benefit ranking, wherein the social-media popularity ranking is determined according to the number of social-media associations created by users to an advertisement, an advertiser, a promotion, and/or a product or a service, and the perceived user benefit ranking is determined according to a monetary value of a promotion offered by an advertiser, a time period of the promotion, and/or a geographical proximity of the promotion to the user;
a data transmission component configured to transmit the one or more ranked advertisements to the computer; and
a display component configured to display the one or more selected advertisements according to their perceived user benefit and/or social-media popularity rank.

In addition to the exemplary aspects and embodiments described above, further aspects and embodiments will become apparent by reference to the drawings and by study of the following detailed descriptions.

### BRIEF DESCRIPTION OF DRAWINGS

The accompanying drawings show non-limiting example embodiments.

FIG. 1 is a diagram of a system according to an embodiment of the invention.

FIG. 2 is a flow chart of a process according to an embodiment of the invention.

FIG. 3 is a flow chart according to an embodiment of the invention.

FIG. 4 is a flow chart according to an embodiment of the invention.

FIG. 5 is a model of a display according to an embodiment of the invention.

FIG. 6 is a model of a display according to an embodiment of the invention.

FIG. 7 is a model of a display according to an embodiment of the invention.

FIG. 8 is a model of a display according to an embodiment of the invention.

FIG. 9 is a model of a display according to an embodiment of the invention.

FIG. 10 is a model of a display according to an embodiment of the invention.

FIG. 11 is an advertisement applet according to an embodiment of the invention.

Throughout the drawings and description like reference symbols are used to indicate like elements.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

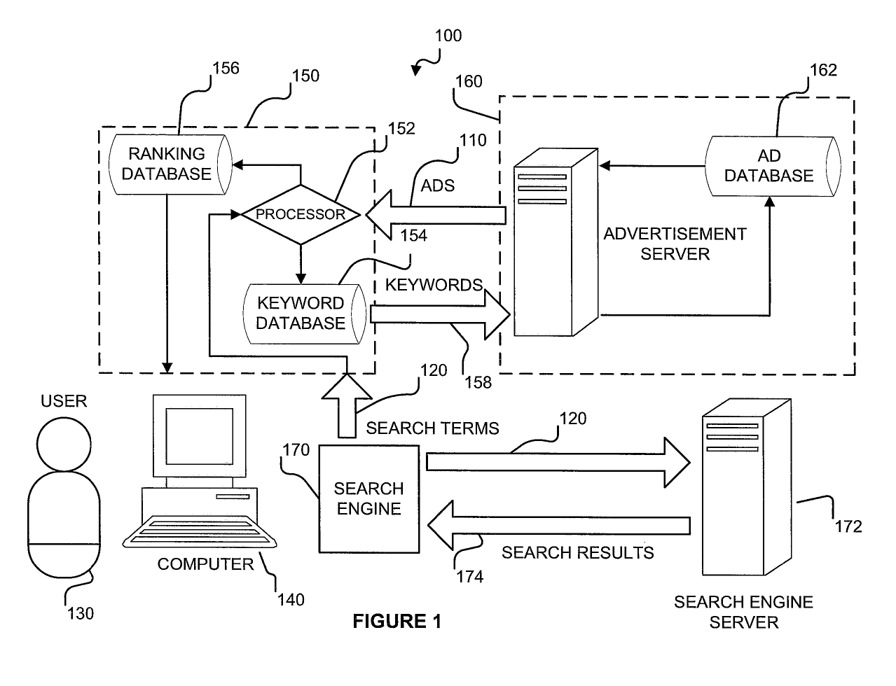

FIG. 1 is a diagram of an example embodiment of a system 100 for providing advertisements 110 relevant to search terms 120 that are input by user 130 using a computer 140. The system 100 is shown having a module 150, comprising a processor 152, a module keyword database 154, and a ranking database 156. The system is also shown having an advertisement server 160, comprising an advertisement database 162. Also depicted are keywords 158, a search engine 170, search engine server 172, and search results 174.

The module 150 receives search terms 120 from computer 140, while search engine 170 independently performs its usual function of sending search terms 120 to search engine server 172 and receiving search results 174. Search engine 170 may be a primary search engine such as Google®, Yahoo®, Bing® and the like where search engine server 172 derives search results from the entire Internet, or may be a secondary search engine where search engine server 172 derives search results from a subset of the Internet. A subset of the Internet could, for example, be a website with any intra-website search capabilities such as the websites operated by Wikipedia®, eBay®, Amazon® and the like.

Search terms 120 are also analyzed by processor 152 by being compared to a module keyword database 154 wherein the module keyword database 154 associates search terms 120 with keywords 158. Module 150 then transmits keywords 158 corresponding to search terms 120 to advertisement server 160.

Advertisement server 160 retrieves relevant advertisements 110 through a comparison of keywords 158 to advertisement database 162. Advertisement database 162 may comprise an advertisement keyword database. Advertisement server 160 transmits relevant advertisements 110 to the module 150.

Processor 152 may rank advertisements 110 through the use of ranking database 156. Module 150 then causes one or more advertisements 110 to be displayed on computer 140 to be viewed by user 130. Advertisements 110 may be displayed according to rank. In some embodiments, advertisements 110 may be ranked ordinally, with the most preferred advertisement 110 appearing at the top of the set of a plurality of advertisements 110. Additionally or alternatively, the more preferred advertisements 110 may be displayed in other visually dominant ways over less preferred advertisements 110, such as by use of larger advertisement space, longer display time, larger fonts, more prominent colour schemes and the like. In yet other embodiments, only the most preferred advertisement 110 may be displayed to user 130. In other embodiments, advertisements 110 may not be ranked.

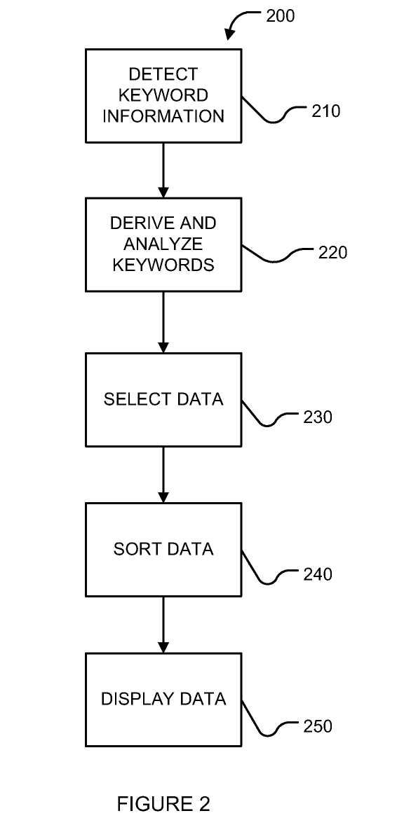

FIG. 2 shows a flow chart of a process 200 according to one embodiment of the invention. In block 210 keyword information is detected. Keyword information comprises identifiers used to determine subject matter relevant to a user at a particular time. Keyword information generally comprises one or more words in any language. However, other identifiers may be used such as numbers, colours, shapes, sounds, images and the like.

Keyword information may be detected from any number of source modules. For example, as in the embodiment shown in FIG. 1, the source module may be a search engine, and keyword information may comprise search terms detected from user inputs into the search engine.

Keyword information may also be detected from the text of an active document on a computer. A document may comprise any program, window, algorithm, code or the like, which is controllable by a user of a computer. Some examples of documents include a text viewing program, a text editing program, a web browser, and a computer game. An active document may mean any document that is selected by a user of a computer, any document the contents of which are visible to a user of a computer, or any document that is running on a computer (any document that occupies a processor or has been loaded such that a user could interact with the document).

Keyword information may be detected from the text of an active document by analyzing the text to determine the topic of the text. For example, this may be applied to website pages, electronic books, or documents being created in a text editor among many others. The analysis may be performed by methods known to those skilled in the art. A simple example is to determine the frequency of each word in a document and selecting the words with the highest frequency. Common words such as “the” may, of course, be excluded. Other methods of determining the topic of text are known to those skilled in the art.

Keyword information may also be detected from particular portions of an active document. For example, keyword information may be detected from the subject line of an email, the title of a book, the title of a website page, the title of a website document, and the like. For example, the subject line of an email may be detected by examining a document for the word “subject” and detecting words that are proximal thereto. The title of a book may be detected by analyzing the uppermost text of a book document for example. The title or subject matter of a website page or website document may be detected by analyzing the metadata or meta-title of the website page.

It is not necessary that keyword information be detected solely from text. Other content such as colours, sounds, images and video may provide input from which keyword information can be detected. For example, if a user watches a news video about the conditions at ski hills, the subject of the video may be detected and “ski hill” may be detected as keyword information. Another example may be the detection of keyword information from sound files. Voice recognition algorithms or software may be used to detect keyword information from audio content. Voice recognition software may also be used to detect keyword information from user audio input.

Keyword information may also be detected from user input generally. For example, the keyboard strokes of a user of a personal computer may be detected and keyword information detected from that input. Methods for detecting keyboard input are known in the art. User input may be detected from other input devices such as touch screens, “mice”, microphones and the like. Detection of keyword information in this case may take place at particular time intervals such that advertisements displayed to a user are relevant to a user's current subject. For example, the time interval could range from 15 seconds to 15 minutes, and preferably from 30 seconds to 60 seconds.

In block 220 keywords are derived from keyword information. Keyword derivation may comprise determining the most frequently occurring word(s) in the keyword information. Keyword derivation may comprise a comparison of detected keyword information to a keyword database.

In block 220 keywords are also analyzed. Keyword analysis may comprise the ranking of keywords. Keywords may be ranked by various factors. For example, if two derived keywords are “soccer” and “digital camera”, the keyword “digital camera” may be ranked higher if the ranking factor is “more corresponding advertisements in an advertisement database”. Ranking factors may include the quantity of advertisements associated with a keyword (as in the previous example), the quality of advertisements associated with a keyword, the popularity of a keyword, the likelihood that a keyword is associated with an advertisement, and the like. The ranking of a keyword may be used to determine the number of advertisements selected in association with that keyword, the manner (e.g. order) in which of advertisements are displayed to a user, and the like.

In block 230 the relevant data is selected. In preferred embodiments, and as described generally above, the data comprises advertisements. In other embodiments, the data may comprise other information of interest to a user. For example, the data may comprise messages broadcast over a network, such as “tweets” broadcast over the Internet from users of the website Twitter™. In another example, these messages may comprise “profile updates” provided by users of the Facebook® website. In yet another example, the data may comprise short news summaries of current events or other stories of interest to a user.

The data may be selected from a database comprising a list of data entries. In preferred embodiments the data entries are associated with one or more keywords. In embodiments where the data comprises messages broadcast over a network, the user may specify what the parameters of the database such as which sources or what time periods to include. For example, the sources may be specified as users of Twitter that are associated with, or “followed” by, a particular user of Twitter. In another example, the sources may be specified as particular news services.

In a preferred embodiment the data is selected from a database comprising advertisements. Advertisements in the database may be associated with one or more keywords. Keywords may be associated with an advertisement explicitly in the database or may be associated implicitly, such as when one or more keywords appear in the content of the advertisement. Advertisements may be selected when the keywords correspond to one or more keywords associated with that advertisement.

The selected data is sorted in block 240. The data may be sorted according to ranking factors comprising relevance, popularity, and/or perceived user benefit. According to preferred embodiments of the invention, ranking factors do not include, and are independent of, keyword click bid amounts.

Ranking according to popularity may comprise a number of algorithms. Popularity may be determined by the popularity of an advertisement, the popularity of an advertiser, the popularity of a product, the popularity of a service, and/or other topics connected to the advertisement. The popularity of these topics may be determined in a number of ways.

In some embodiments, the popularity of an advertisement may be determined by the number of times an advertisement has been displayed, the number of times an advertisement has been “clicked” (i.e. the number of times it has been engaged by a user by viewing the advertiser's website), the number of times an advertisement has resulted in further action by the user (e.g. registration and/or purchase by a user).

In some embodiments, popularity may be determined by social-media factors. Popularity may be based on the number of users of one or more social-media sites who associate themselves with the topic in question. An association may directed to a particular advertisement, advertiser, product or service, and may comprise creation of a like/tag/mention/comment/share, engagement of a follower/friend/fan/member, and the like. For example, popularity may be based upon the number of “tweets” published. As another example, if a new cellular phone A is liked by 1,000 users of a social-media website such as Facebook, while new cellular phone B is liked by 500 users of the same website, an advertisement for cellular phone A may be assigned a higher popularity ranking than cellular phone B. Popularity may be based on reviews of the topic in question, be it of the advertisement, advertiser, promotion, product, service, or other topic connected to the advertisement. For example, reviews considered may be from dedicated review sites such as Epinions®, Yelp®, Consumer Reports® and the like, and vendor sites that include customer reviews of products and services such as Amazon®, Best Buy®, Travelocity® and the like.

Popularity may be based on one or more social-media factors. In embodiments where popularity is based on a plurality of social-media factors, cumulative popularity may be determined. Cumulative popularity may comprise a summation of one or more metrics such as total followers/friends/fans/members, total net positive reviews/ratings, total likes/tags/mentions/comments/shares and the like.

In some embodiments, social-media factors may be weighted according to factors such as time period and number of reviews/ratings. For example, reviews created within the past year may be weighted more than reviews/ratings created more than one year ago, and reviews based on more than 10 reviews may be weighted more than ratings based on less than 10 reviews. In some embodiments, certain thresholds for consideration may apply; for example, only reviews and associations created within the past year may be considered, and only ratings based on more than 10 reviews may be considered.

Ranking according to perceived user benefit may also comprise a number of algorithms. A perceived user benefit ranking may be based upon the monetary value of a promotion offered in an advertisement. For example, a promotion could comprise discounts, promotional prices, 2 for 1 promotions, sample products, free service trial periods, free product/service upgrades, bonus products/services, referral fees, customer loyalty points, contest entries, and the like. Where the promotion is a discount, the perceived user benefit ranking may be based on the actual or percentage amount of the discount. Where the promotion is a promotional price, the perceived user benefit ranking may be based on the difference between promotional price and the average market price of similar items. Where the promotion is a sample product, free trial service period, free product/service upgrade, or bonus product/service the perceived user benefit ranking may be based on the average market price of the free item or upgrade. Where the promotion is referral fees or customer loyalty points, the benefit ranking may be based on the monetary amount of the fees or the monetary equivalent of the points. Where the promotion is a contest entry, the benefit ranking may be based on the monetary value of the prize, optionally adjusted according to the chances of winning.

A perceived user benefit ranking may also be based on the time period of the promotion. Certain promotions may only be active on or for particular dates and advertisements may be ranked higher or lower depending on when the promotion may expire.

A perceived user benefit ranking may also be based on the geographical proximity of an advertiser to a user. For example, an advertisement associated with an advertiser located in Alexandria, Va. may be assigned a higher benefit ranking than an advertisement associated with an advertiser located in Seattle, Wash. for a user located in Alexandria. In this context, the location of an advertiser to a user may comprise the meaning “the location at which the goods or services offered by the advertiser are available”. The location of a user may be determined according to methods known to those skilled in the art, for example, through the identification of the Internet Protocol (IP) address, or Global Positioning Satellite (GPS) position of a user.

An advertisement may be ranked according to any or all of the factors described above. The rankings may be combined and rankings may be assigned importance values. For example, a benefit ranking may comprise a combination of a percentage discount ranking and a geographical proximity ranking. In another example, a ranking may comprise a weighted average of a social-media ranking, a perceived user benefit ranking and a relevance ranking. As a result, advertisements may be sorted according to ranking.

In one example, a keyword is “Italian food” and a user is located in New York City, N.Y. Restaurant X is located in Queens, N.Y., has received reviews of 80% from a social-media review site, and has an advertisement for 40% off an entree which is associated with the keyword “Italian food”. Restaurant Y is located in New York City, has received reviews of 40% from a social-media review site and has an advertisement for 50% off a pizza, which is associated primarily with the keyword “pizza” and secondarily with the keyword “Italian food”. The advertisement for restaurant X may receive a lower benefit ranking due to the lower proximity to the user and a lower percentage discount in its advertisement and a higher popularity and relevance ranking due to its review scores and keyword association. Restaurant Y conversely may receive a higher benefit ranking due to closer proximity to the user and a higher percentage discount, and a lower popularity and relevance ranking due to its review scores and keyword association. Overall, either restaurant's advertisement may be assigned a higher ranking depending on the weight assigned to each factor.

The data is displayed in block 250 of FIG. 2. Data may be displayed in various ways on various types of computers. In a preferred embodiment, data may be displayed in a sidebar of a main window of an operating system of a computer. A sidebar includes any graphical user interface element which allows the display of information within a portion of a viewing area of a computer. A sidebar may, for example, be located to the side, top, or bottom of the main application being used by the user. Sidebars are typically designed to provide easy access to applets, which are typically specialized mini-applications that provide information and other services. A sidebar may also refer to an independent program which allows data to be displayed in an independent display section of a computer.

The display of data in a sidebar allows for the data to remain visible independent of other activities of a user. In some embodiments, this means that advertisements which have been selected on the basis of search terms entered into a search engine remain independently viewable by a user even after the search page is no longer visible or has been terminated. Therefore, a user may still be exposed to advertisements that are relevant to their search terms throughout the time that they are performing the search. This is beneficial to both the user, as they may not have to reperform a search query and also may have extended access to relevant and beneficial advertisements, and to the advertiser, as their advertisements may be viewed by the user for an extended period of time, increasing the value of the advertisement and the likelihood of further user engagement (e.g. registration and/or purchase).

In some embodiments, the sidebar may be visible only when one or more particular applications are in use. In other embodiments, the sidebar may be visible regardless of which, if any, applications are in use. In some embodiments, the sidebar may automatically resize to occupy lateral screen space not occupied by the window(s) of any currently running application(s).

### EXAMPLES

The invention is further described with reference to the following specific examples, which are not meant to limit the invention, but rather to further illustrate it.

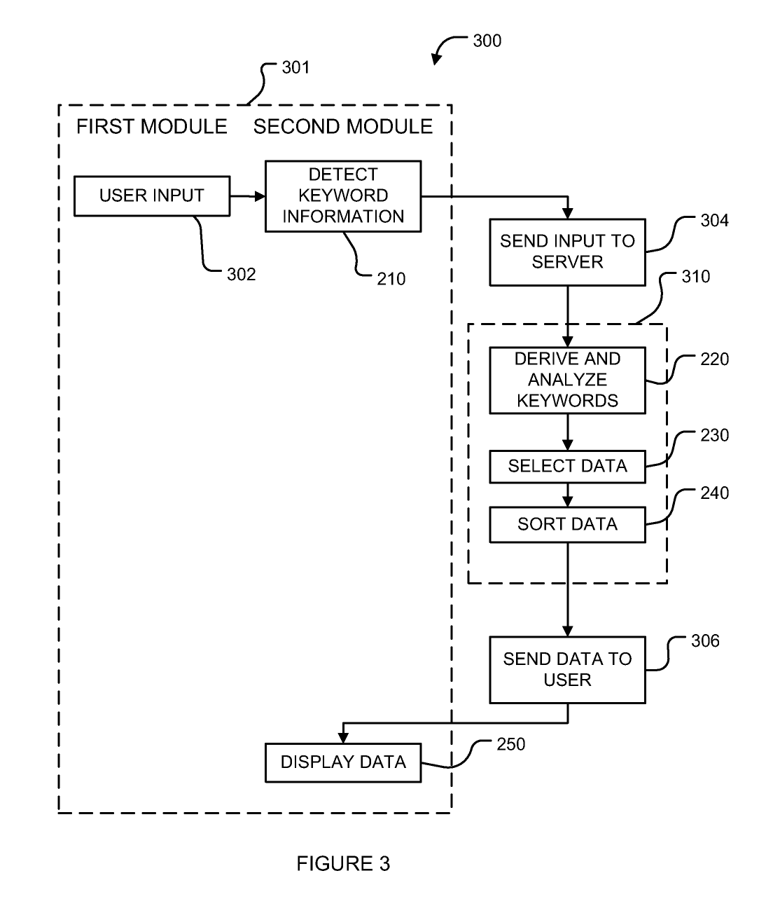

FIG. 3 is a flow chart of a process 300 according to an example embodiment of the technology. This example illustrates one possible distribution of the steps of the process between a user device 301 and a server 310. In particular, user input is accepted on user device 301 by a first module in block 302 through any variety of means known to those skilled in the art. Keyword information may be detected from this input by a second module on the user device 301 in block 210. The keyword information may then be transmitted to a server 310 in block 304 over a network such as the Internet. The keywords may then be derived and analyzed in block 220 and data may be selected and sorted in blocks 230, 240. Once the data is sorted, it may be communicated back to the user device 301 in block 306 and displayed by the second module in block 250.

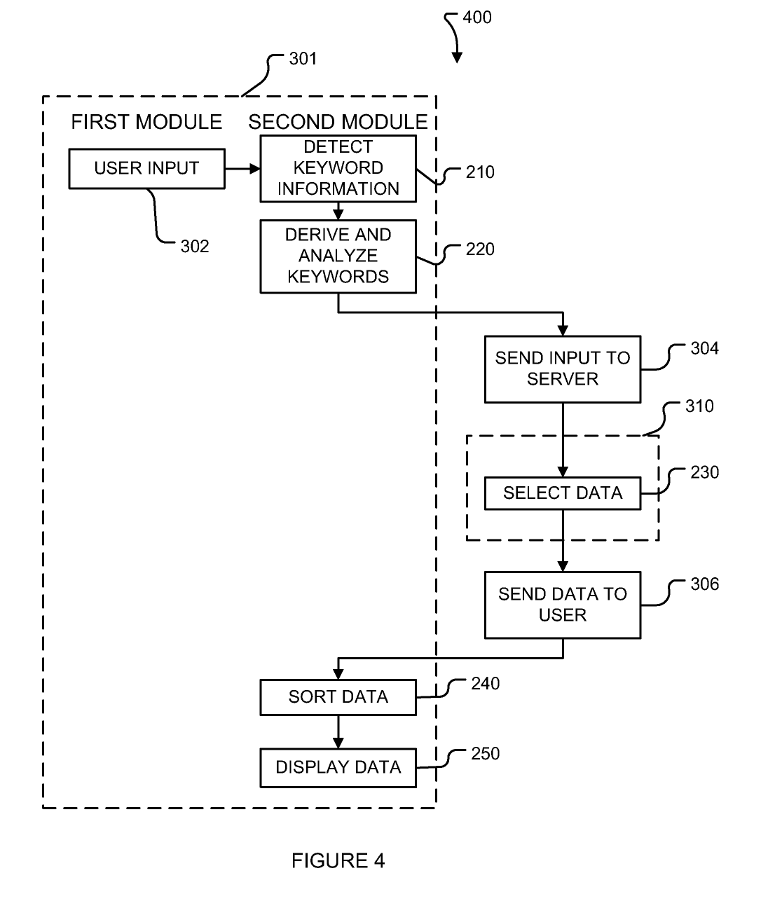

FIG. 4 is a flow chart of another process 400 according to an embodiment of the present invention. In this example, after the user input is received by the first module of the user device 301 in block 302, the steps of blocks 210, 220, 240 and 250 are performed by the second module on the user device, while only the step of block 230 is performed by the server 310. The information is transmitted to and from the server 310 in blocks 304 and 306. Numerous variations of these distributions of tasks are possible.

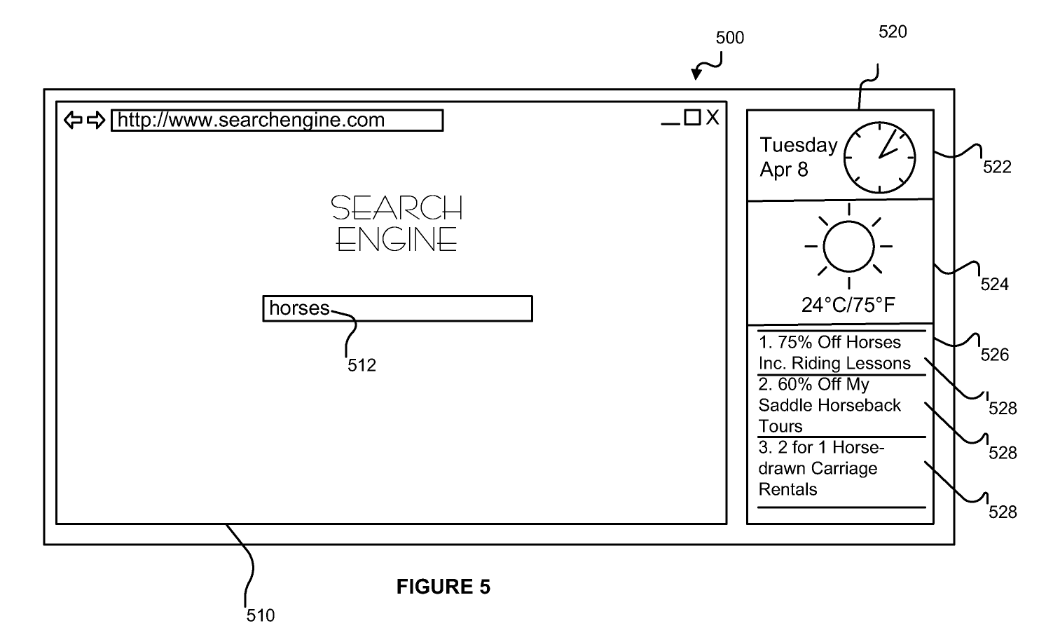

FIG. 5 is an example search display 500 according to an embodiment of the present invention. The search display 500 comprises a search engine 510 and a sidebar 520. Shown in search engine 510 is search term 512. Sidebar 520 is shown with a time and date applet 522, a weather applet 524 and an advertising applet 526 comprising advertisements 528 according to an embodiment of the technology. Advertising applet 526 shows example advertisements related to search term 512, and is an example embodiment of display block 250 of the embodiments shown in FIGS. 2-4. In this example, advertisements 528 are ranked in order of percentage discount.

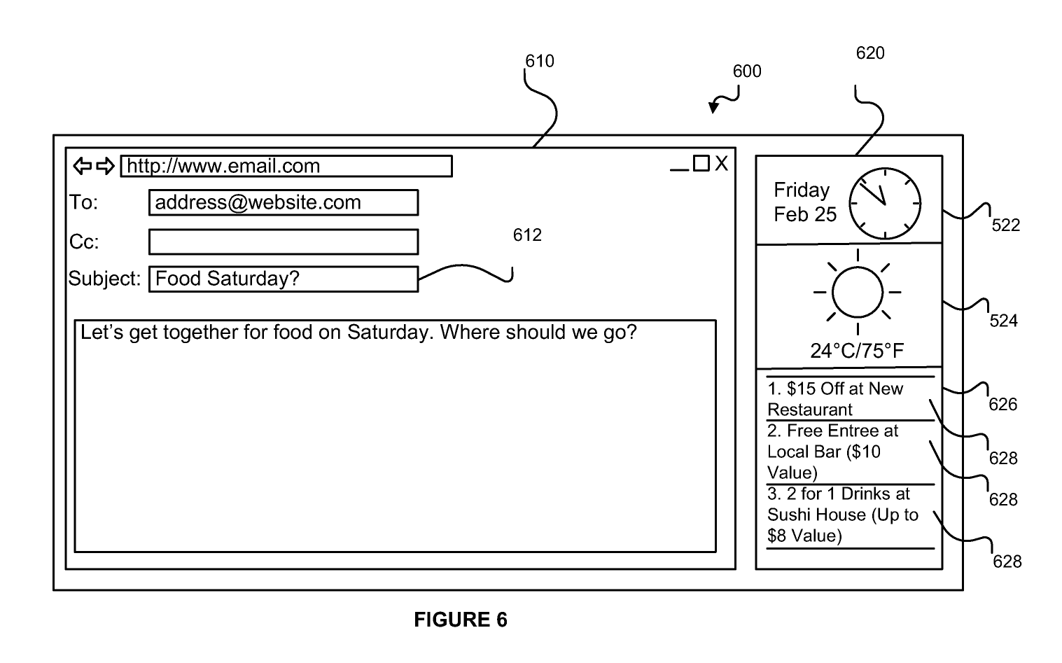

FIG. 6 is an example display 600 of a website based email application according to an embodiment of the present invention. The display 600 comprises an email composition website 610 and a sidebar 620. Shown in email composition website 610 is subject line 612. Sidebar 620 is shown with a time and date applet 522, a weather applet 524 and an advertising applet 626 comprising advertisements 628 according to an embodiment of the technology. Advertising applet 626 shows example advertisements related to subject line 612, and is an example embodiment of display block 250 of the embodiments shown in FIGS. 2-4. In this example, advertisements 628 are ranked in order of monetary discount.

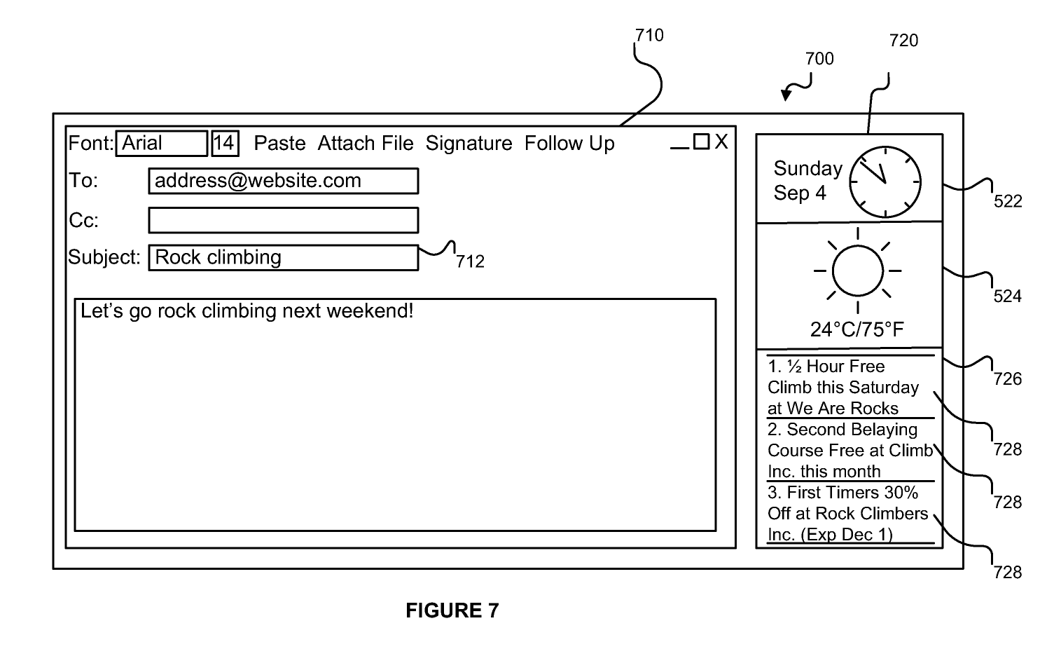

FIG. 7 is an example display 700 of an email application according to an embodiment of the present invention. The display 700 comprises an email composition program 710 and a sidebar 720. Shown in email composition program 710 is subject line 712. Sidebar 720 is shown with a time and date applet 522, a weather applet 524 and an advertising applet 726 comprising advertisements 728 according to an embodiment of the technology. Advertising applet 726 shows example advertisements related to subject line 712, and is an example embodiment of display block 250 of the embodiments shown in FIGS. 2-4. In this example, advertisements 728 are ranked according to the expiry of the advertisements 728.

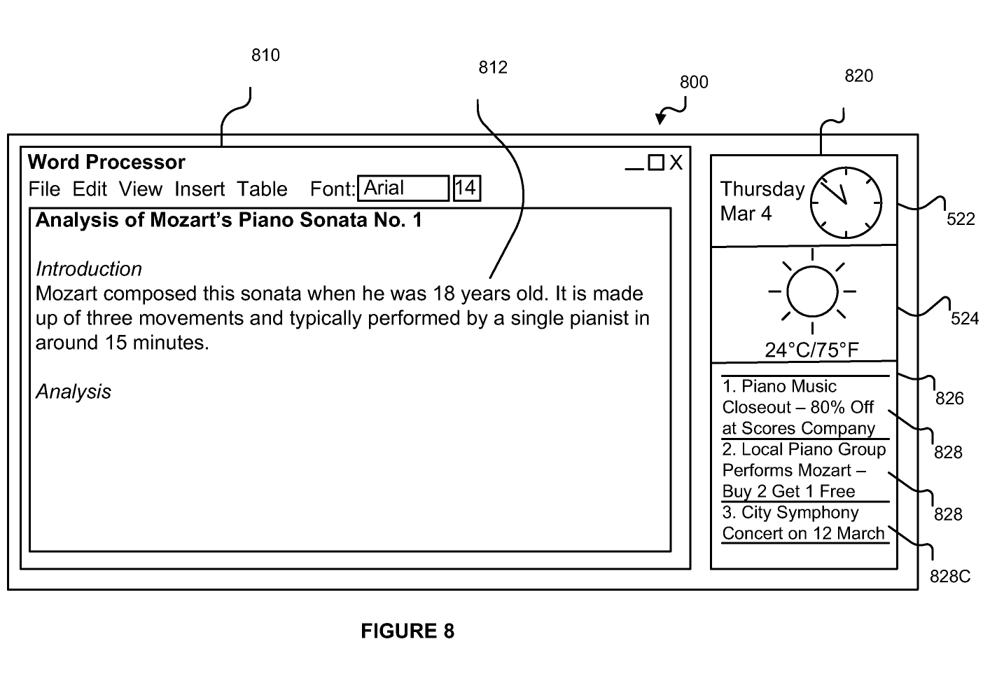

FIG. 8 is an example display 800 of a word processing application according to an embodiment of the present invention. The display 800 comprises word processor program 810 and a sidebar 820. Shown in word processor program 810 is text 812. Sidebar 820 is shown with a time and date applet 522, a weather applet 524 and an advertising applet 826 comprising advertisements 828 according to an embodiment of the technology. Advertising applet 826 shows example advertisements related to the subject of text 812, and is an example embodiment of display block 250 of the embodiments shown in FIGS. 2-4. In this example, advertisements 828 are ranked in order of percentage discount and according to the expiry of the advertisements 828. Therefore, while example advertisement 828C does not provide a discount, its approaching expiry date results in it being displayed.

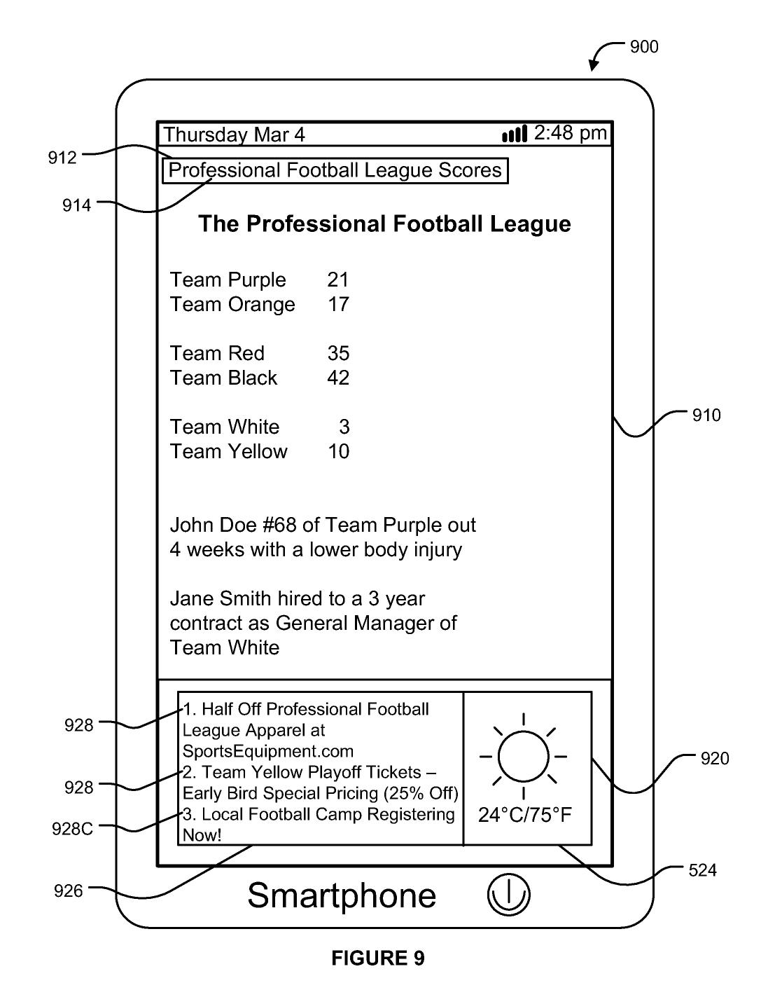

FIG. 9 is an example of a cellular telephone application according to an embodiment of the present invention. The telephone 900 comprises information display 910 and a sidebar 920. Shown in information display 910 is search term entry field 912 containing search terms 914. Sidebar 920 is shown with a weather applet 524 and an advertising applet 926 comprising advertisements 928 according to an embodiment of the present invention. Advertising applet 926 shows example advertisements related to search terms 914, and is an example embodiment of display block 250 of the embodiments shown in FIGS. 2-4. In this example, advertisements 928 are ranked in order of percentage discount and according to the geographical proximity to the user of advertisements 928. Therefore, while example advertisement 928C does not provide a discount, its proximity to the user result in it being displayed to the user.

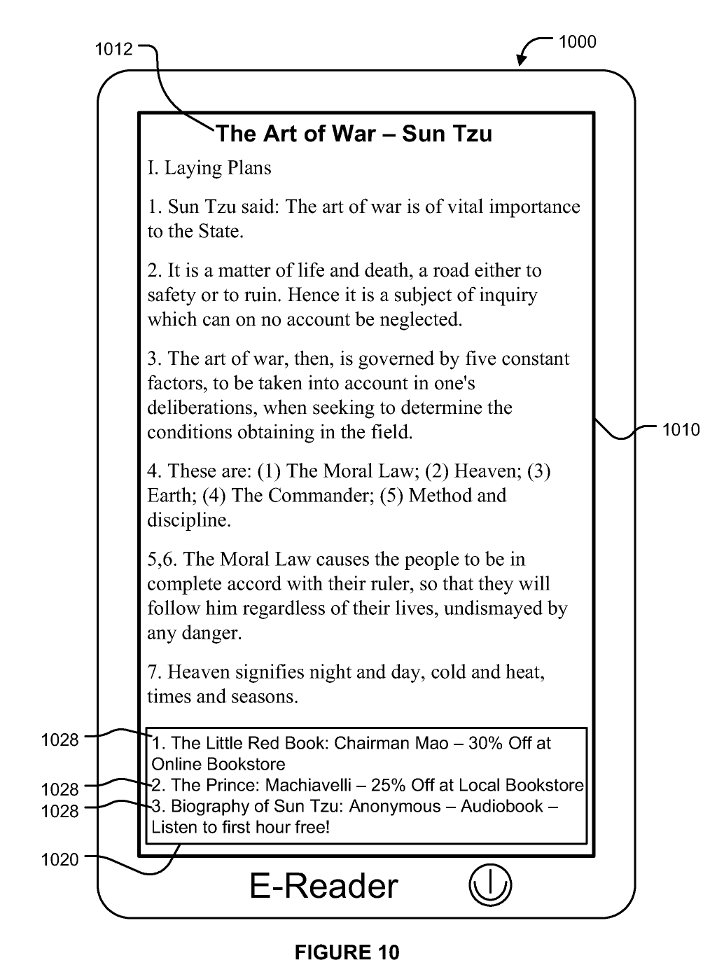

FIG. 10 is an example of an electronic book reader (e-reader) application of the technology. The e-reader 1000 comprises text display 1010 and a sidebar 1020. Shown in text display 1010 is title 1012. Sidebar 1020 is shown comprising advertisements 1028 according to an embodiment of the invention. Sidebar 1020 shows example advertisements related to the title 1012, and is an example embodiment of display block 250 of the embodiments shown in FIGS. 2-4. In this example, advertisements 1028 are ranked in order of percentage discount.

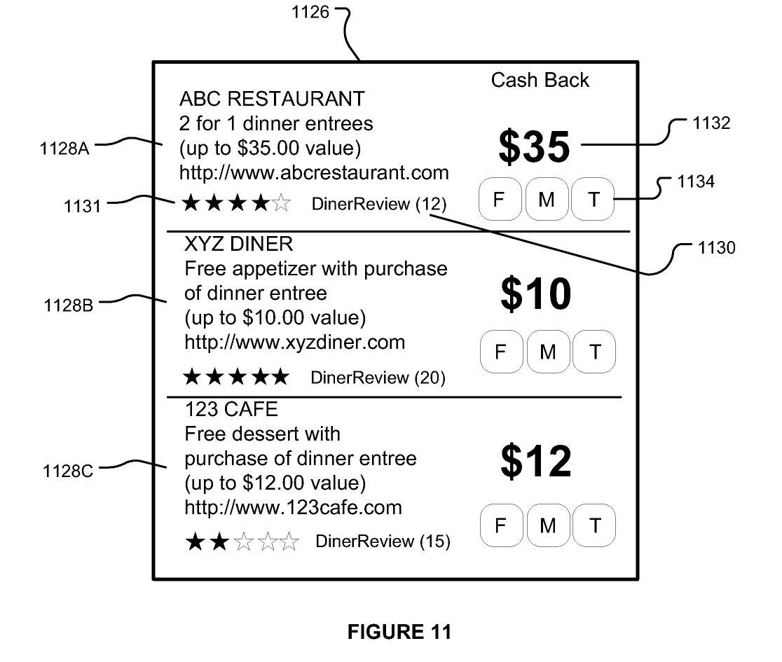

FIG. 11 is an example an advertising applet 1126 according to another embodiment of the invention. Advertising applet 1126 may be employed in any sidebar embodiment of the invention, including sidebars 520, 620, 720, 820, 920, and 1020. Advertising applet 1126 is shown displaying advertisements 1128A, 1128B and 1128C. Advertisements may include the name of the advertiser, a brief description of the promotion, and a hyperlink to the advertiser's website. Advertisements 1128A, 1128B and 1128C are ranked in order of a weighted combination of popularity and perceived user benefit. In the embodiment shown, popularity is based on third party website review indicators 1130, wherein the third party review site is identified (and may be hyperlinked), as well as the number of user reviews of the advertiser (in parentheses) at a third party review site, and the cumulative user review scores 1131 according to that third party review site. Here, the selection of data in block 230 of the embodiments shown in FIGS. 2-4 involves selecting only advertisers with greater than 10 user reviews at this third party review site. In the embodiment shown, perceived user benefit is based on the cash value of the discount offered by the advertisers. The cash value may be indicated in prominent text 1132.

In advertising applet 1126 the ranking of data in block 240 of the embodiments shown in FIGS. 2-4 assigns certain weight to both popularity and perceived user benefit, thus in this case the higher ranking of advertisement 1128B over advertisement 1128C, i.e., although advertisement 1128C offers a slightly higher discount than advertisement 1128B, advertisement 1128B has a substantially higher cumulative user review score 1130 than 1128C. Advertisements 1128A, 1128B and 1128C may also include social-media links 1134 for users to immediately share the advertisement with others, associate themselves with the advertisement, and the like. In some embodiments, users may save the advertisements onto a clipboard or the like for later use.

Systems and modules described herein may comprise software, firmware, hardware, or any combination(s) thereof suitable for the purposes described herein. A system or module may perform one or more function, and one piece of software, firmware or hardware may perform the function(s) of one or more system or module. Systems and modules may reside on general purpose computers such as servers, workstations, personal computers, computerized tablets, personal digital assistants (PDAs), and other devices suitable for the purposes described herein. Those skilled in the relevant art will appreciate that aspects of the system can be practiced with other communications, data processing, or computer system configurations, including: Internet appliances, hand-held devices (including PDAs and e-readers), wearable computers, all manner of cellular or mobile phones, multi-processor systems, microprocessor-based or programmable consumer electronics, set-top boxes, network PCs, mini-computers, mainframe computers, and the like. The terms “computer”, “server” and the like are generally used interchangeably herein, and refer to any of the above devices and systems, as well as any data processor. Furthermore, aspects of the system can be embodied in a special purpose computer or data processor that is specifically programmed, configured, or constructed to perform one or more of the computer-executable instructions explained in detail herein.

Systems and modules may be accessible via local memory, via a network, via a browser or other application in an ASP context, or via other means suitable for the purposes described herein. Examples of the technology can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

Examples of the technology may be stored or distributed on computer readable media, including magnetically or optically readable computer discs, hardwired or preprogrammed chips (e.g., EEPROM semiconductor chips), nanotechnology memory, biological memory, or other data storage media. Computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

Where a component (e.g. an assembly, device, etc.) is referred to above, unless otherwise indicated, reference to that component (including reference to a means) should be interpreted as including as equivalents of that component any component which performs the same function as the described component, including components which are not structurally equivalent to the disclosed structures which perform the function in the illustrated exemplary embodiments of the invention.

Processes, methods, lists and the like are presented in a given order. Alternative examples may be performed in a different order, and some elements may be deleted, moved, added, subdivided, combined, and/or modified to provide alternative or subcombinations. Each of these elements may be implemented in a variety of different ways. Also, while elements are at times shown as being performed in series, they may instead be performed in parallel, or may be performed at different times. Some elements may be of a conditional nature, which is not shown for simplicity.

Unless the context clearly requires otherwise, throughout the description and the claims, the words “comprise,” “comprising,” and the like are to be construed in an inclusive sense, that is, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, shall refer to this document as a whole and not to any particular portions. Where the context permits, words using the singular or plural number may also include the plural or singular number respectively. The word “or,” in reference to a list of two or more items, covers all of the following interpretations of the word: any of the items in the list, all of the items in the list, and any combination of the items in the list.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for displaying advertisements on a computer comprising:
detecting keyword information from a source module with a data processor wherein the keyword information is visible to a user on a display component of the computer;
comparing the keyword information to a keyword database wherein the keyword database associates the keyword information with one or more keywords;
comparing the one or more keywords to an advertisement database wherein the advertisement database associates the one or more keywords with one or more advertisements; and
displaying the one or more advertisement on the display component through a sidebar module, wherein the sidebar module is viewable by the user independently of the visibility of the source module.

2. A method according to claim 1 wherein the step of detecting the keyword information comprises detecting words displayed in the source module.

3. A method according to claim 2 wherein the source module is a search engine and wherein the keyword information corresponds to search terms input into the search engine by the user.

4. A method according to claim 3 wherein the one or more advertisements comprises a plurality of advertisements and further comprising the step of ranking the plurality of advertisements before the step of displaying the one or more advertisements.

5. A method according to claim 4 wherein the step of ranking comprises ranking according to perceived user benefit.

6. A method according to claim 8 wherein ranking according to perceived user benefit comprises ranking according to one or more of: monetary value of a promotion offered by an advertiser; time period of the promotion; and
geographical proximity of the promotion to the user.

7. A method according to claim 4 wherein the step of ranking comprises ranking according to social-media popularity of: an advertisement; an advertiser; a promotion offered in the advertisement; and/or a product or a service featured in the promotion.

8. A method according to claim 7 wherein social-media popularity is determined by the number of social-media associations created by users to the advertisement, the advertiser, the promotion and/or the product or the service.

9. A method according to claim 8 wherein the social-media associations comprise generation of a like, tag, mention, comment or share, and/or engagement as a follower, friend, fan, or member.

10. A method according to claim 1 comprising the steps of:
transmitting the keyword information to a server comprising the keyword database and the advertisement database wherein the server is connected to the computer by a network; and
communicating the one or more advertisements to the computer from the server.

11. A computer program product comprising a computer readable medium having control logic stored therein for causing a computer to display advertisements on the computer, the control logic comprising:
first computer readable program code means for causing the computer to detect keyword information from a source module with a data processor wherein the keyword information is visible to a user on a display component of the computer;
second computer readable program code means for causing the computer to compare the keyword information to a keyword database wherein the keyword database associates the keyword information with one or more keywords;
third computer readable program code means for causing the computer to compare the one or more keywords to an advertisement database wherein the advertisement database associates the one or more keywords with one or more advertisements; and
fourth computer readable program code means for causing the computer to display the one or more advertisement on the display component through a sidebar module, wherein the sidebar module is viewable by the user independently of the visibility of the source module.

12. An advertisement display system comprising:
a source module running on a computer;
a processor configured to detect keyword information from the source module;
a keyword database;
a processor configured to derive one or more keywords based on a comparison between the keyword information and the keywords stored in the keyword database;
an advertisement database which stores a plurality of advertisements, each advertisement being associated with one or more advertisement keywords;
a processor configured to select one or more advertisements based on a comparison between the one or more keywords and the one or more advertisement keywords;
a data transmission component configured to transmit the one or more selected advertisements to the computer; and
a sidebar comprising a display component configured to display the one or more selected advertisements, wherein the sidebar is independently viewable from the source module.

13. A system according to claim 12 wherein the source module is a search engine and wherein the keyword information corresponds to search terms input into the search engine by the user.

14. A system according to claim 13 wherein the one or more advertisements comprises a plurality of advertisements and further comprising a processor configured rank the plurality of advertisements.

15. A system according to claim 14 wherein the processor configured to rank the plurality of advertisements ranks according to perceived user benefit and/or social-media popularity.

16. A method for displaying advertisements on a computer comprising:
detecting keyword information from a source module with a data processor wherein the keyword information is visible to a user on a display component of the computer;
comparing the keyword information to a keyword database wherein the keyword database associates the keyword information with one or more keywords;
comparing the one or more keywords to an advertisement database wherein the advertisement database associates the one or more keywords with one or more advertisements;
ranking the one or more advertisements according to perceived user benefit; and
displaying the one or more advertisements on a display component according to their perceived user benefit ranking.

17. A method according to claim 16 wherein ranking according to perceived user benefit comprises ranking according to one or more of: monetary value of a promotion offered by an advertiser; time period of the promotion; and geographical proximity of the promotion to the user.

18. A computer program product comprising a computer readable medium having control logic stored therein for causing a computer to display advertisements on the computer, the control logic comprising:
first computer readable program code means for causing the computer to detect keyword information from a source module with a data processor wherein the keyword information is visible to a user on a display component of the computer;
second computer readable program code means for causing the computer to compare the keyword information to a keyword database wherein the keyword database associates the keyword information with one or more keywords;
third computer readable program code means for causing the computer to compare the one or more keywords to an advertisement database wherein the advertisement database associates the one or more keywords with one or more advertisements;
fourth computer readable program code means for causing the computer to rank the one or more advertisements according to perceived user benefit; and
fifth computer readable program code means for causing the computer to display the one or more advertisements on a display component according to their perceived user benefit ranking.

19. An advertisement display system comprising:
a source module running on a computer;
a processor configured to detect keyword information from the source module;
a keyword database;
a processor configured to derive one or more keywords based on a comparison between the keyword information and the keywords stored in the keyword database;
an advertisement database which stores a plurality of advertisements, each advertisement being associated with one or more advertisement keywords;
a processor configured to select one or more advertisements based on a comparison between the one or more keywords and the one or more advertisement keywords and to rank the one or more selected advertisements according to perceived user benefit;
a data transmission component configured to transmit the one or more ranked advertisements to the computer; and
a display component configured to display the one or more ranked advertisements according to their perceived user benefit rank.

20. A method for displaying advertisements on a computer comprising:
detecting keyword information from a source module with a data processor wherein the keyword information is visible to a user on a display component of the computer;
comparing the keyword information to a keyword database wherein the keyword database associates the keyword information with one or more keywords;
comparing the one or more keywords to an advertisement database wherein the advertisement database associates the one or more keywords with one or more advertisements;
ranking the one or more advertisements according to social-media popularity; and
displaying the one or more advertisements on the display component according to their social-media popularity ranking.

21. A method according to claim 20 wherein the social-media popularity comprises social-media popularity of an advertisement, an advertiser, a promotion offered in the advertisement, and/or a product or a service featured in the promotion.

22. A method according to claim 21 wherein the social-media popularity is determined by the number of social-media associations created by users to the advertisement, the advertiser, the promotion and/or the product or the service.

23. A method according to claim 22 wherein the social-media associations comprise generation of a like, tag, mention, comment or share, and/or engagement as a follower, friend, fan, or member.

24. A computer program product comprising a computer readable medium having control logic stored therein for causing a computer to display advertisements on the computer, the control logic comprising:
first computer readable program code means for causing the computer to detect keyword information from a source module with a data processor wherein the keyword information is visible to a user on a display component of the computer;
second computer readable program code means for causing the computer to compare the keyword information to a keyword database wherein the keyword database associates the keyword information with one or more keywords;
third computer readable program code means for causing the computer to compare the one or more keywords to an advertisement database wherein the advertisement database associates the one or more keywords with one or more advertisements;
fourth computer readable program code means for causing the computer to rank the one or more advertisements according to social-media popularity; and
fifth computer readable program code means for causing the computer to display the one or more advertisements on the display component according to their social-media popularity ranking.

25. An advertisement display system comprising:
a source module running on a computer;
a processor configured to detect keyword information from the source module;
a keyword database;
a processor configured to derive one or more keywords based on a comparison between the keyword information and the keywords stored in the keyword database;
an advertisement database which stores a plurality of advertisements, each advertisement being associated with one or more advertisement keywords;
a processor configured to select one or more advertisements based on a comparison between the one or more keywords and the one or more advertisement keywords and to rank the one or more advertisements according to social-media popularity;
a data transmission component configured to transmit the one or more ranked advertisements to the computer; and
a display component configured to display the one or more ranked advertisements according to their social-media popularity rank.

26. A method for displaying advertisements comprising the steps of:
detecting keyword information input by a user into a search engine via a terminal with a terminal processor;
deriving keywords from the keyword information with the terminal processor;
transmitting the keywords to a server connected to the terminal via a network;
selecting a plurality of advertisements stored in a database on the server wherein the advertisements correspond to the keywords;
ranking the advertisements according to a social-media popularity ranking and/or a perceived user benefit ranking, wherein the social-media popularity ranking is determined according to the number of social-media associations created by users to an advertisement, an advertiser, a promotion, and/or a product or a service, and the perceived user benefit ranking is determined according to a monetary value of a promotion offered by an advertiser, a time period of the promotion, and/or a geographical proximity of the promotion to the user;
communicating the ranked advertisements from the server to the terminal; and
displaying the ranked advertisements to the user of the terminal through a sidebar, wherein the sidebar is viewable to the user independent of visibility of the search engine.

27. A computer program product comprising a computer readable medium having control logic stored therein for causing a computer to display advertisements on the computer, the control logic comprising:
first computer readable program code means for causing the computer to detect keyword information from a source module with a data processor wherein the keyword information is visible to a user on a display component of the computer;
second computer readable program code means for causing the computer to derive keywords from the keyword information with the terminal processor;
third computer readable program code means for causing the computer to transmit the keywords to a server connected to the terminal via a network;
fourth computer readable program code means for causing the computer to select a plurality of advertisements stored in a database on the server wherein the advertisements correspond to the keywords;
fifth computer readable program code means for causing the computer to rank the advertisements according to a social-media popularity ranking and/or a perceived user benefit ranking, wherein the social-media popularity ranking is determined according to the number of social-media associations created by users to an advertisement, an advertiser, a promotion, and/or a product or a service, and the perceived user benefit ranking is determined according to a monetary value of a promotion offered by an advertiser, a time period of the promotion, and/or a geographical proximity of the promotion to the user;
sixth computer readable program code means for causing the computer to communicate the ranked advertisements from the server to the terminal; and
seventh computer readable program code means for causing the computer to display the ranked advertisements to the user of the terminal through a sidebar, wherein the sidebar is viewable to the user independent of visibility of the search engine.

28. An advertisement display system comprising:
a source module running on a computer;
a processor configured to detect keyword information from the source module;
a keyword database;
a processor configured to derive one or more keywords based on a comparison between the keyword information and the keywords stored in the keyword database;
an advertisement database which stores a plurality of advertisements, each advertisement being associated with one or more advertisement keywords;
a processor configured to select one or more advertisements based on a comparison between the one or more keywords and the one or more advertisement keywords and to rank the one or more advertisements according to a social-media popularity ranking and/or a perceived user benefit ranking, wherein the social-media popularity ranking is determined according to the number of social-media associations created by users to an advertisement, an advertiser, a promotion, and/or a product or a service, and the perceived user benefit ranking is determined according to a monetary value of a promotion offered by an advertiser, a time period of the promotion, and/or a geographical proximity of the promotion to the user;
a data transmission component configured to transmit the one or more ranked advertisements to the computer; and
a display component configured to display the one or more selected advertisements according to their social-media popularity ranking and/or a perceived user benefit ranking.
